(19) United States
(12) Patent Application Publication
(10) Pub. No.: US 2021/0064984 A1
(43) Pub. Date: Mar. 4, 2021

(54) ENGAGEMENT PREDICTION USING MACHINE LEARNING IN DIGITAL WORKPLACE

(71) Applicant: SAP SE, Walldorf (DE)

(72) Inventors: Qiu Shi Wang, Singapore (SG); Lin Cao, Singapore (SG)

(21) Appl. No.: 16/554,745

(22) Filed: Aug. 29, 2019

(51) Int. Cl. G06N 3/08; G06N 5/02; G06Q 10/06

(52) U.S. Cl. CPC G06N 3/08; G06Q 10/0631; G06N 5/02

(57) ABSTRACT

Methods, systems, and computer-readable storage media for receiving, by a ML service of the ML-based engagement prediction platform, static data including static operational data and static experience data as enterprise master data (EMD) from an EMD database, providing, by the ML service, a static trained ML model by training a ML model using the static data, receiving, by the ML service, dynamic data including content data, providing, by the ML service, a dynamic trained ML model by training the static trained ML model using the dynamic data, generating, by the ML service, one or more predicted engagement scores using the dynamic trained ML model, and providing, by a digital workplace of the ML-based engagement prediction platform, a UI that includes an interactive chart that is rendered and bound with the one or more engagement scores using UI metadata that enables the interactive chart to be rendered across multiple channels.

### BACKGROUND

Employment patterns are evolving in the current epoch of the knowledge economy and digital working environment. As the millennial generation becomes the major workforce, the rise of new trends, such as freelance employment, gig economy, employment by contractor and subcontractor, a globally distributed and intangible workforce, agile and shorter product and project cycles make employee engagement more challenging than ever before. Enterprises use analytics-based tools for tracking engagement, which tools depend on data collected from employee surveys and other feedback channels. Such analytics are usually static and retrospective, and cannot reflect the current employee engagement status, much less predict future trends. Consequently, it is difficult for enterprises to take proactive or preventive actions in a fast-paced working environment that often includes a rapidly changing team.

### SUMMARY

Implementations of the present disclosure are directed to an engagement prediction platform for predicting engagement within enterprises. More particularly, implementations of the present disclosure are directed to using a machine learning (ML) model that is trained using both static data and dynamic data in a multi-stage training process and is deployed to provide real-time engagement prediction.

In some implementations, actions include receiving, by a ML service of the ML-based engagement prediction platform, static data including static operational data and static experience data as enterprise master data (EMD) from an EMD database, providing, by the ML service, a static trained ML model by training a ML model using the static data, receiving, by the ML service, dynamic data including content data, providing, by the ML service, a dynamic trained ML model by training the static trained ML model using the dynamic data, generating, by the ML service, one or more predicted engagement scores using the dynamic trained ML model, and providing, by a digital workplace of the ML-based engagement prediction platform, a user interface (UI) that includes an interactive chart that is rendered and bound with the one or more engagement scores using UI metadata that enables the interactive chart to be rendered across multiple channels. Other implementations of this aspect include corresponding systems, apparatus, and computer programs, configured to perform the actions of the methods, encoded on computer storage devices.

These and other implementations can each optionally include one or more of the following features: the static experience data includes one or more historical engagement scores calculated based on at least a portion of the static experience data; actions further include providing one or more time-series data, each time-series data including a first portion including one or more historical engagement scores and a second portion including at least one predicted engagement score of the one or more predicted engagement scores; the static operational data includes operational data based on agent interactions with one or more software system executed within the enterprise, the one or more software systems including one or more of an enterprise resource planning (ERP) system, a customer relationship management (CRM) system, and a human capital management (HCM) system; the content data is specific to a set of agents of multiple sets of agents within the enterprise to provide the dynamic trained ML model as specific to the set of agents; the content data includes data provided from one or more of verbal communications of agents and textual communications of agents; and the ML model includes a deep neural network (DNN).

The present disclosure also provides a computer-readable storage medium coupled to one or more processors and having instructions stored thereon which, when executed by the one or more processors, cause the one or more processors to perform operations in accordance with implementations of the methods provided herein.

The present disclosure further provides a system for implementing the methods provided herein. The system includes one or more processors, and a computer-readable storage medium coupled to the one or more processors having instructions stored thereon which, when executed by the one or more processors, cause the one or more processors to perform operations in accordance with implementations of the methods provided herein.

It is appreciated that methods in accordance with the present disclosure can include any combination of the aspects and features described herein. That is, methods in accordance with the present disclosure are not limited to the combinations of aspects and features specifically described herein, but also include any combination of the aspects and features provided.

The details of one or more implementations of the present disclosure are set forth in the accompanying drawings and the description below. Other features and advantages of the present disclosure will be apparent from the description and drawings, and from the claims.

### DESCRIPTION OF DRAWINGS

FIG. 1 depicts an example architecture that can be used to execute implementations of the present disclosure.

FIG. 2 depicts an example architecture in accordance with implementations of the present disclosure.

FIGS. 3A and 3B depict example user interfaces (UIs) in accordance with implementations of the present disclosure.

FIG. 4 depicts an example process that can be executed in accordance with implementations of the present disclosure.

FIG. 5 is a schematic illustration of example computer systems that can be used to execute implementations of the present disclosure.

Like reference symbols in the various drawings indicate like elements.

### DETAILED DESCRIPTION

Implementations of the present disclosure are directed to an engagement prediction platform for predicting engagement within enterprises. More particularly, implementations of the present disclosure are directed to using a machine learning (ML) model that is trained using both static data and dynamic data in a multi-stage training process and is deployed to provide real-time engagement prediction. Implementations can include actions of receiving, by a ML service of the ML-based engagement prediction platform, static data including static operational data and static experience data as enterprise master data (EMD) from an EMD database, providing, by the ML service, a static trained ML model by training a ML model using the static data, receiving, by the ML service, dynamic data including content data, providing, by the ML service, a dynamic trained ML model by training the static trained ML model using the dynamic data, generating, by the ML service, one or more predicted engagement scores using the dynamic trained ML model, and providing, by a digital workplace of the ML-based engagement prediction platform, a user interface (UI) that includes an interactive chart that is rendered and bound with the one or more engagement scores using UI metadata that enables the interactive chart to be rendered across multiple channels.

To provide further context for implementations of the present disclosure, and as introduced above, employment patterns are evolving in the current epoch of the knowledge economy and digital working environment. As the millennial generation becomes the major workforce, the rise of new trends, such as freelance employment, gig economy, employment by contractor and subcontractor, and a globally distributed and intangible workforce, agile and shorter product and project cycles make employee engagement more challenging than ever before. Traditionally, enterprises use analytics-based tools for tracking engagement, which tools depend on data collected from employee surveys and other feedback channels. Such analytics are usually static and retrospective, and cannot reflect the current engagement status, much less predict future trends. Consequently, it is difficult for enterprises to take proactive or preventive actions in a fast-paced working environment that often includes a rapidly changing team. In some examples, actions and remedies an enterprise may take to affect engagement are usually after the fact. For example, high-performing employees may have already been lost by the time the enterprise realizes that there is an engagement issue.

In view of the above context, implementations of the present disclosure provide a platform for real-time prediction of employee engagement, which enables enterprises to take preemptive action to mitigate engagement issues and/or avoid an engagement issue altogether. More particularly, implementations of the present disclosure provide an engagement prediction platform that uses one or more ML models that are trained using both static data and dynamic data in a multi-stage training process and are deployed to provide real-time engagement prediction. As described in further detail herein, implementations of the present disclosure use enterprise master data to train a ML model that is used to predict engagement, the master data including static data and dynamic data. The ML model is statically trained in a first stage, and dynamically trained in a second stage, and is deployed to provide real-time engagement prediction.

In general, engagement can be described as a measure of a relationship between entities. In the context of the present disclosure, engagement is representative of a relationship between agents (e.g., employees) of an enterprise and the enterprise. For example, agents having a relatively higher engagement can be described as being absorbed by and enthusiastic about their work (e.g., having a positive attitude about the enterprise and their work). Such agents have a higher likelihood of taking positive actions to further the efforts of the enterprise and remain with the enterprise. On the other hand, agents having a relatively low engagement can be described as being disengaged, which can include, for example, doing minimum work, and/or actively damaging the efforts of the enterprise.

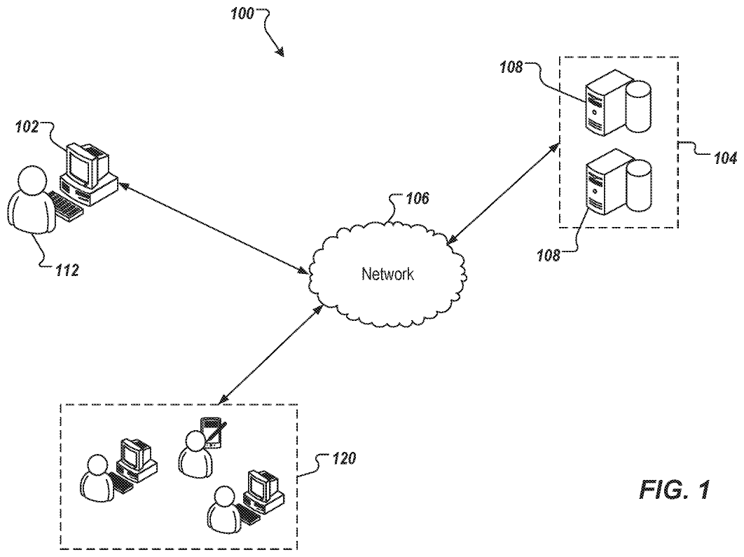

FIG. 1 depicts an example architecture 100 in accordance with implementations of the present disclosure. In the depicted example, the example architecture 100 includes a client device 102, a network 106, and a server system 104. The server system 104 includes one or more server devices and databases 108 (e.g., processors, memory). In the depicted example, a user 112 interacts with the client device 102.

In some examples, the client device 102 can communicate with the server system 104 over the network 106. In some examples, the client device 102 includes any appropriate type of computing device such as a desktop computer, a laptop computer, a handheld computer, a tablet computer, a personal digital assistant (PDA), a cellular telephone, a network appliance, a camera, a smart phone, an enhanced general packet radio service (EGPRS) mobile phone, a media player, a navigation device, an email device, a game console, or an appropriate combination of any two or more of these devices or other data processing devices. In some implementations, the network 106 can include a large computer network, such as a local area network (LAN), a wide area network (WAN), the Internet, a cellular network, a telephone network (e.g., PSTN) or an appropriate combination thereof connecting any number of communication devices, mobile computing devices, fixed computing devices and server systems.

In some implementations, the server system 104 includes at least one server and at least one data store. In the example of FIG. 1, the server system 104 is intended to represent various forms of servers including, but not limited to a web server, an application server, a proxy server, a network server, and/or a server pool. In general, server systems accept requests for application services and provides such services to any number of client devices (e.g., the client device 102 over the network 106).

In accordance with implementations of the present disclosure, and as noted above, the server system 104 can host an engagement prediction platform. For example, the user 112 interacts with the engagement prediction platform to view one or more user interfaces (UIs) that display engagement metrics and engagement scores, as described in further detail herein.

As also depicted in FIG. 1, agents 120 (e.g., employees, contractors) of an enterprise can conduct activities on behalf of the enterprise. For example, an enterprise can execute operations using software systems. In some examples, multiple software systems provide respective functionality. In some examples, the agents 120 of the enterprise interface with enterprise operations through a so-called digital workplace. A digital workplace can be described as a central interface, through which a user (e.g., agent, employee) can access all the digital applications required to perform respective tasks in operations of the enterprise. Example digital applications include, without limitation, enterprise resource planning (ERP) applications, customer relationship management (CRM) applications, human capital management (HCM) applications, email applications, instant messaging applications, virtual meeting applications, and social media applications. Example digital workplaces include, without limitation, VMWare Workspace One, Citrix Workspace, and SAP Fiori Launchpad. In the example of FIG. 1, a digital workplace can be hosted by the server system 104.

As introduced above, the present disclosure provides an engagement prediction platform that uses one or more ML models that are trained using both static data and dynamic data in a multi-stage training process and are deployed to provide real-time engagement prediction. In further detail, and as described herein, the engagement prediction platform of the present disclosure uses one or more ML models that are trained using enterprise master data (EMD) to provide engagement predictions. In some implementations, EMD data integrates data sources across different sources in an enterprise landscape. In some examples, the EMD includes operational data (O-Data) and experience data (X-Data). O-Data include data generated from enterprise operations and can be generated and managed by enterprise software systems such as ERP, CRM, HCM, and the like. X-Data can be considered as qualitative data that is contextualised with human factors and includes satisfaction levels and various aspects of human experience.

In further detail, users (e.g., the agents 120 of FIG. 1) can interacts with a digital workplace that includes a set of applications (e.g., an ERP application, a CRM application, a HCM application, an email application, a social media application). In some examples, one or more applications in the set of applications are used by users in performing tasks on behalf of the enterprise. For example, and without limitation, a set of users can perform tasks related to sales, a set of users can perform tasks related to customer support, and a set of users can perform tasks related to research and development (R&D).

In some implementations, the set of applications are organized and controlled by the digital workplace system. That is, for example, the users access the applications through a UI of the digital workplace system. In some implementations, all of the usage data of the applications in the set of applications across all users within an enterprise (or multiple enterprises) can be collected. For example, as the users interact with applications, log entries are generated, which provide the usage data. As another example, user interactions with entities external to the enterprise can be represented in data (e.g., emails, telephone calls). In some examples, one or more databases are provided as a persistence service of the digital workplace system and record transaction records of every application in the set of applications, as well as other data representative of user activities.

In accordance with implementations of the present disclosure, the EMD can be categorized into multiple classes including static data and dynamic data. In some examples, EMD is categorized based on a so-called readiness of the data. For example, static data includes historical data from the past months or years, and includes responses to questionnaires (e.g., employee surveys, customer satisfaction surveys). Dynamic data is data that is recently generated or generated on-the-fly. An example is data generated from textual analysis and speech recognition of communications between customers and a support team, in which information regarding the satisfaction levels, sentiments and other aspects of human experience are extracted on-the-fly (e.g., text and/or speech are processed to provide a sentiment category and/or a satisfaction category). For example, and without limitation, employees who work in a customer support team may possess and generate a variety of data as presented in the Table 1 below:

TABLE 1
Example Data for Customer Support Team

| Type | Operational Data (O-Data) | Experience Data (X-Data) |
|---|---|---|
| Static | CRM Workflow | Employee surveys |
| | Customer cases | Customer feedback |
| | Employee Compensation/ | |
| | Performance/ | |
| | Learning | |
| Dynamic | Timesheet logging | Text analytics of customer |
| | Current customer call | communications |
| | tickets | Speech recognition of customer |
| | | conversations |

The O-Data and the X-Data provided from a variety of static and dynamic data sources are pipelined, integrated and orchestrated by a data integration service, referred to herein as a data hub. An example data hub includes the SAP Data Hub provided by SAP SE of Walldorf, Germany. In some examples, the data hub processes the O-Data and X-Data into the EMD, which can be considered a single source of truth. The EMD is used by a ML service for training one or more ML models.

Implementations of the present disclosure use a ML model for predicting engagement scores. In some implementations, the ML model is provided as deep neural network (DNN) and is trained using a multi-stage supervised regression algorithm for time series prediction. In some implementations, the ML model predicts engagement scores based on a set of defined metrics. In some examples, the set of metrics can be customized for different enterprises having different lines of operations. For example, the metrics for a customer support team may include compensation, management recognition, satisfaction, wellness, personal growth, goal alignment, inter- and intra-team relationships, among others.

In some implementations, the EMD is processed in-memory to achieve complex and high-volume computation. That is, the EMD can be stored in the main random-access memory (RAM) of one or more servers, enabling much faster processing speeds than could be achieved in other data storage paradigms (e.g., data stored in relational databases and/or on disk drives). In this manner, engagement predictions (engagement scores) are provided in real-time (e.g., without any intentional delay). In some examples, the engagement scores are representative of future engagements that would result, if the enterprise continues operations without adjustment to affect engagement.

In accordance with implementations of the present disclosure, the ML model is trained in multiple stages. In some implementations, the multiple stages include a first stage and a second stage.

In the first stage, the ML model is trained using static data. For example, the ML model is trained with static data and historical engagement scores. The static data includes O-Data and X-Data from a time period (e.g., past days, weeks, months, years). The historical engagement scores are provided as analytic results of historical surveys. In some examples, during training, the static data is provided as input to the ML model to generate output (e.g., engagement scores). The engagement scores output during training are compared to the historical engagement scores. In some examples, an error between the output and the historical engagement scores. Iterations of training are conducted in an effort to minimize the error. In some examples, at each iteration, one or more attributes of the ML model are adjusted in an effort to reduce the error in the next iteration. Once the error is below a threshold error, the ML model is determined to be trained, and the training process ends. At the end of the first stage, the ML model can be considered to be a static-trained ML model and is stored in a model repository.

In the second stage, the ML model (i.e., static-trained ML model) is trained using dynamic data. In some examples, the static-trained ML model is retrieved from the model repository, and further trained with dynamic data to optimize the model for a specific period and group of employees. In accordance with implementations of the present disclosure, the dynamic training fits the ML model to a stream of dynamic data. The dynamic data is only incrementally available in time sequence. Because the dynamic data arrives incrementally (i.e., is not available entirely at once), measures, such as mean and standard deviation, are unknown in advance, the dynamic data cannot be labelled accordingly (e.g., with such measures). In view of this, implementations of the present disclosure apply machine learning algorithms that are capable of performing incremental learning. For example, a gradient descent algorithm (e.g., stochastic gradient descent, batch gradient descent) can process a small dataset, which is currently available in real-time. In every iteration, the error gradient for the current ML model is estimated, and weights of the ML model are updated with backpropagation. The amount that the weights are updated by during training is defined as a learning rate, which can be a set value. Through many iterations of training, optimal values of the parameters are provided for the dynamic ML model. At the end of the second stage, the ML model can be considered to be a fully-trained ML model and is stored in the model repository.

In use, the ML model (i.e., fully-trained ML model) is loaded by an inference engine, which processes incoming data to provide engagement scores based on the ML model. That is, the ML model processes the input to generate engagement scores representative of future engagements that would result, if the enterprise continues operations without adjustment to affect engagement.

In some implementations, a time-series of engagement scores is provided and includes historical engagement scores (e.g., from analytics of historical data) and current and future engagement scores provided from the ML model. In some examples, the time-series of engagement scores is displayed as an interactive chart, as described in further detail herein. In some examples, the interactive chart is rendered and bound with engagement scores by a metadata-driven UI technology, which can render the interactive chart across multiple channels (e.g., phones, tablets, desktop computers), with no additional coding.

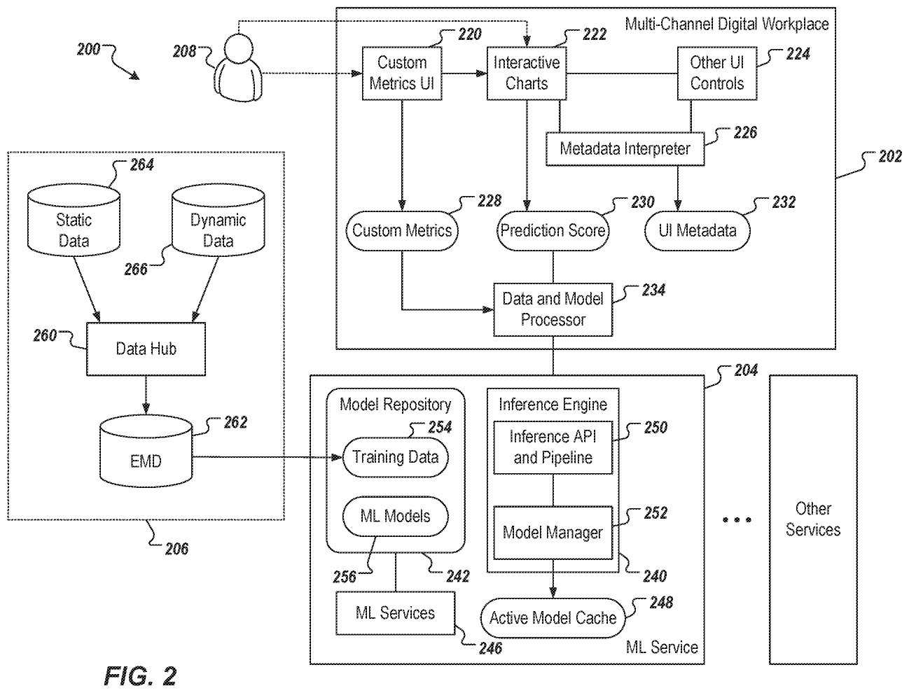

FIG. 2 depicts an example architecture 200 in accordance with implementations of the present disclosure. In the depicted example, the example architecture includes a multi-channel digital workplace system 202, a ML service 204, and a data system 206. One or more users 208 interact with the multi-channel digital workplace system 202 to perform respective tasks in enterprise operations. In some examples, the multi-channel digital workplace system 202 is cloud-based, running on a public cloud or a private cloud.

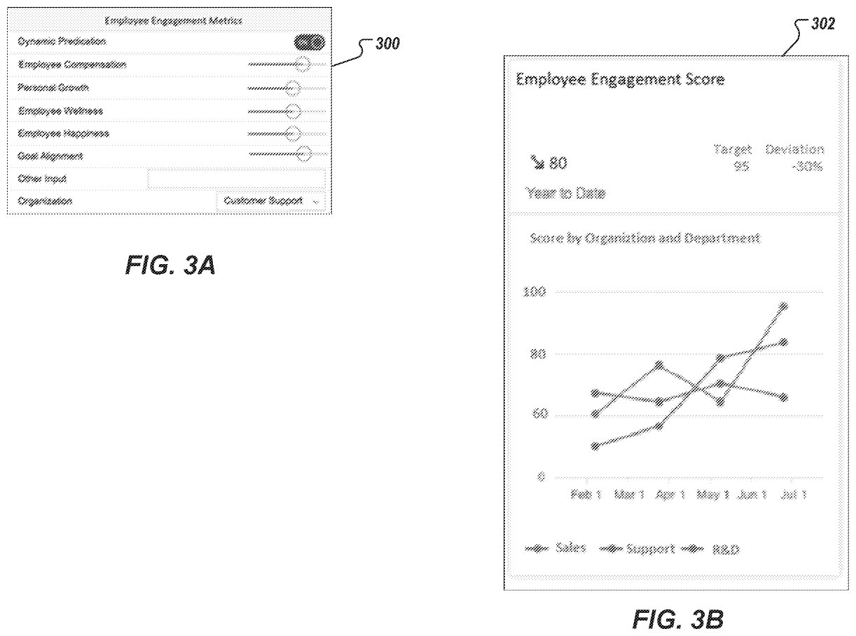

In the example of FIG. 2, the multi-channel digital workplace system 202 includes a custom metrics UI module 220, an interactive charts UI module 222, one or more other UI controls modules 224, a metadata interpreter 226, a custom metrics store 228, a prediction score store 230, a UI metadata store 232, and a data and model processor module 234. In some examples, the custom metrics UI module 220 generates a custom metrics UI that the user 208 can use to set engagement metrics. The custom metrics defined through the custom metrics UI are stored in the custom metrics store 228. An example customer metrics UI is described in further detail herein with reference to FIG. 3A. In some examples, the interactive charts UI module 222 generates an interactive chart based on predicted engagement score(s), as described in further detail herein. For example, the interactive charts UI module 222 reads one or more engagement prediction scores from the prediction score store 230 and generates an interactive chart based thereon. In some examples, the interactive charts UI module 222 generates the interactive charts based on UI metadata that is retrieved from the UI metadata store 232 and that is interpreted by the metadata interpreter 226. An example interactive chart is described in further detail herein with reference to FIG. 3B.

In some implementations, the UI metadata is defined in hierarchical structure. In some examples, the outmost level contains the Page Caption, Page name and Type. In a page, an array of UI controls is provided and a composite control (e.g., Sections) can include an array of UI controls recursively. Each control has its own properties that specify how the UI control is rendered. An event hander (e.g., OnValueChange) to specify what action occurs when the event is triggered. In some examples, the metadata interpreter 226 is implemented as a cross-platform runtime library to be integrated into the digital workplace. The implementation may include a JSON parser to parse the metadata, an action angine to generate cross-platform script, and a native UI control dispatcher to call native controls in UI module 222 and the one or more other UI controls modules 224, respectively. For example, the Control.Type.Chart in metadata will be parsed by the JSON parser and properties (e.g., caption, target, visibility) are retrieved and used as parameters for a call to render the chart. The interactive chart has respective implementations with native UI elements on different platforms. Example code is provided as:

{

“Caption”: “Employee Engagement Metrics”,
“Controls”: [
{

“Sections”: [

{

“Caption”: “Dynamic Prediction”,

“Value”: true,
“Visible”: true,
“OnValueChange”:

“/Actions/OnDynamicPredictionChange.action”,

“_Name”: “DynamicSwitch”,
“_Type”: “Control.Type.FormCell.Switch”

},
{

“Caption”: “Employee Compensation”,
“Value”: /Actions/StaticValue.action,
“Visible”: true,
“OnValueChange”:

“/Actions/NewDynamicPrediction.action”,

“_Name”: “EmployeeCompensation”,
“_Type”: “Control.Type.FormCell.Slider”

},
{

“Caption”: “Personal Growth”,
“Value”: /Actions/StaticValue.action,
“Visible”: true,
“OnValueChange”:

“/Actions/NewDynamicPrediction.action”,

“_Name”: “PersonalGrowth”,
“_Type”: “Control.Type.FormCell.Slider”

},
{

“Caption”: “Employee Wellness”,
“Value”: /Actions/StaticValue.action,
“Visible”: true,
“OnValueChange”:

“/Actions/NewDynamicPrediction.action”,

“_Name”: “EmployeeWellness”,
“_Type”: “Control.Type.FormCell.Slider”

},
{

“Caption”: “Employee Happiness”,
“Value”: /Actions/StaticValue.action,
“Visible”: true,
“OnValueChange”:

“/Actions/NewDynamicPrediction.action”,

“_Name”: “EmployeeHappiness”,
“_Type”: “Control.Type.FormCell.Slider”

},
{

“Caption”: “Goal Alignment”,
“Value”: /Actions/StaticValue.action,
“Visible”: true,
“OnValueChange”:

“/Actions/NewDynamicPrediction.action”,

“_Name”: “GoalAlignment”,
“_Type”: “Control.Type.FormCell.Slider”

},
{

“Caption”: “Goal Alignment”,
“Value”: /Actions/StaticValue.action,
“Visible”: true,
“OnValueChange”:

“/Actions/NewDynamicPrediction.action”,

“_Name”: “GoalAlignment”,
“_Type”: “Control.Type.FormCell.Slider”

},
{

“Caption”: “Other input”,
“Value”: /Actions/StaticValue.action,
“Visible”: true,
“IsEditable”: Globals/IsEditable.global,
“validationProperties”: {

“ValidationMessage”: “Validation

Message”,

“ValidationMessageColor”: “ff0000”,
“SeparatorBackgroundColor”:
“000000”,
“SeparatorIsHidden”: false,
“ValidationViewBackgroundColor”:

“fffa00”,

“ValidationViewIsHidden”: false

}

“_Name”: “Otherlnput”,

```
    “_Type”:
    “Control.Type.FormCell.SimpleProperty”,
```

},

{

```
  “AllowMultipleSelection”: false,
  “Caption”: “Organization”,
  “OnValueChange”: “/Actions/NewPrediction.action”,
  “PickerItems”: [
```

```
  “CustomerSupport”,
  “Sales”,
  “RnD”
```

```
  ],
  “_Name”: “SwitchOrg”,
  “_Type”: “Control.Type.FormCell.ListPicker”
```

}

]

}

]

“_Name”: “FormCellContainer”,
“_Type”: “Control.Type.FormCellContainer”

“Caption”: “Employee Engagement Score”,
{

“Caption”: “Dynamic Prediction”,
“ChartType”: “Line”
“Visible”: true,
“OnPress”: “/Actions/DrillDown.action”
“Target”: {

```
  “EntitySet”: “EmployeeEngagementScore”,
  “Service”: “/Services/app.service”,
  “QueryOptions”:
```

“$expand=Scores&$orderby=DeptId&$top=3”

}
“_Name”: “ScoreChart”,
“_Type”: “Control.Type.Chart”

},
“_Name”: “EmployeeEngagementPage”,
“_Type”: “Page”

}

In the example of FIG. 2, the ML service 204 includes an inference engine 240, a model repository 242, a ML service module 244, and an active model cache 248. The inference engine 240 includes an inference API and pipeline module 250 and a model manager module 252. The model repository 242 includes a training data store 254 and a ML model store 256.

In accordance with implementations of the present disclosure, the ML service module 244 trains one or more ML models based on usage data provided from the digital workplace system 202. An example ML service includes the SAP Leonardo Machine Learning Services provided by SAP SE of Walldorf, Germany. In further detail, during training of the ML model(s), EMD provided from the data system 206 is read into, the model repository 242, which saves the data in the training data store 254. The data is used to train the ML models by the ML service module 246. The trained ML models are stored in the model repository 242 for subsequent use by the inference engine 240, as described in further detail herein.

In the example of FIG. 2, the data system 206 includes a data hub, EMD 262, static data 264 and dynamic data 266. In some examples, the data hub 260 ingests and process the static data 264 and the dynamic data 266 to provide the EMD 262. In some implementations, the data hub 260 orchestrates any type, variety, and volume of data across the entire distributed enterprise data landscape. The data hub 260 can connect to diverse systems natively and remotely, access data, integrate data and replicate data with customized configuration. For example, the data sources may include data lakes, object stores, databases, data warehouses from different system running both on cloud and on premise. The data hub 260 discovers data in catalogues and profiles, performs data transformations, and define data pipelines and streams. The data hub 260 provides one gateway, which is the EMD 262, with all the data required for any specific data science solution.

In some examples, the static data includes, without limitation, O-Data provided from one or more of the applications agents of the enterprise use (e.g., ERP, CRM, HCM), and X-Data from an experience management (XM) service (e.g., Qualtrics owned by SAP SE of Walldorf, Germany). For example, X-Data can include employee surveys of recent weeks, months, quarters of years, and can include data tables of survey questionnaires and scores in various metrics. Example metrics can include, without limitation, compensation, personal growth, wellness, happiness, goal alignment). Each metric can be associated with several questions that had been answered by agents (e.g., answered as a score between 0-10, or 0-5). In some examples, the X-Data can also include open questions, which can be answered in short text. In some examples, a metrics equation can be defined and customized for different enterprises to adjust the weight of every metric. The scores are labelled with different metrics. In some examples, answers to the open question can be analyzed with a text analytics engine to provide quantitative values. In some implementations, historical engagement scores are provided based on the metrics equation, labelled scores and quantitative values of text analytics, attrition rate, retention rate, and turnover rate (e.g., during a defined period (months, quarters, years). The historical employee engagement scores are provided as static data.

In some examples, the dynamic data includes, without limitation, system log data and current data. Example system log data can include, without limitation, logged agent interactions within the dynamic workplace. For example, time spent by different agents in different applications, and the particular applications the agents used. In some examples, current data (also referred to herein as current content) can include data representative of agent actions in performing tasks within a pre-defined period of time (e.g., last X days, weeks, months, quarter, year). For example, an agent that is part of a customer support team interacts with customers of the enterprise, and such interactions can be represented as current content. Example interactions can include email and/or telephone conversations. In some examples, a speech-to-text engine can be used to transcribe conversations into text. In some examples, text from conversations and/or emails can be processed to generate qualitative values (e.g., sentiment, satisfaction). In some examples, a speech analysis engine can be used to analyze speech and generate qualitative values (e.g., sentiment, satisfaction).

In some implementations, training through use of a ML model includes multiple phases. Example phases include, without limitation, load data, process data, identify features, configure algorithms, train model, deploy model, and host model. In the load data phase, the EMD in the data system 206 is read into the ML service 204. In the process data phase, the EMD is preprocessed. In some examples, preprocessing can include generating additional data (e.g., to calculate the time a user spends on tasks, to provide sentiment values, to provide satisfaction values). In some examples, preprocessing can include normalizing and standardizing the EMD. Normalization makes training less sensitive to the scale of features, that enables more accurate calculation of coefficients of the ML model, for example. In some examples, normalization can include resolving massive outliers and binning issues, such as removing data entries of extremely long application usage times (e.g., caused by operating system sleep). Standardization is used to transform the data with large difference in scales and units to a standard normal distribution (e.g., based on a given mean standard deviation). Standardization can contribute to optimizing performance of subsequent ML training.

In some examples, in the identify features phase, the DMP detects and identifies features in the preprocessed dataset. In some examples, a list of features is provided (e.g., in a plain text file in JSON format). A feature can be described as an input variable that is used in making predictions from an ML model. In the context of the present disclosure, features can include, without limitation, the presence or absence of application names and user identifiers, the time a user spent on an application, a frequency of specific terms (e.g., ticket, calendar), the structure and sequence of usage logging records, logged actions (e.g., updated setting, new entries input). In some examples, the selection of features varies between different enterprises and different departments. Consequently, feature selection can be optimized for different lines of operations and/or different use cases to achieve higher predictive accuracy from respective ML models. Using engagement of a customer support team as a non-limiting example, features related to engagement can include, without limitation, customer rating for call tickets, number of dropped calls in a specific time period, average length of retention period for specific groups of employees, and average time to complete specific regular tasks (e.g., resolving call tickets).

In the configure algorithms phase, parameters for a ML model are configured. In some examples, the ML model is a DNN with multiple layers of logistic regression (LR). In some examples, the ML model can include convolutional layers, making it a convolutional neural network (CNN), which has better performance when encoding and compressing features, and so is more suited to capture the non-linear relationships from experience data (X-data). In some examples, a list of hyper-parameters that change the behavior of the DNN are configured. The hyper-parameters determine the structure of the neural network and the variables that determine how the neural network is trained. In some examples, the hyper-parameters are configured in a JSON plain text file with key/value pairs, where the user (e.g. a data scientist in the individual enterprise) can specify the hyper-parameters. Example hyper-parameters include, without limitation, hyper-parameters related to the structure of the neural network (e.g., number of hidden layers, number of units, dropout, network weight initialization, activation function), and hyper-parameters related to training (e.g., momentum, number of epochs, batch size).

In some examples, the data provided from the EMD can be labelled based on a set of metrics to provide labeled training data that is for supervised training. In some examples, the metrics are provided by the user 208 through the custom metrics UI. In some examples, supervised training includes processing the training data through the ML model to learn a mapping function from the input variables (e.g., labelled scores, quantitative values) to an output variable (e.g., historical engagement scores). In some implementations, regression is applied because the output variable is a real value (i.e., engagement scores). The input data includes X-data (e.g., answers to a list of questions under different metrics), and O-data (e.g., data from ERP, HCM, CRM). All of the inputs can be considered as a multidimensional feature vector and the output as a possible quantitative score for a specific group agents (e.g., a set of users that perform tasks related to sales, a set of users that perform tasks related to customer support, a set of users that perform tasks related to R&D).

With all of the datasets, the list of features and the list of hyper-parameters in place, the ML service 204 is consumed (e.g., on cloud) to execute the ML model training. In the example of FIG. 2, the ML service 204 is separate from the digital workplace system 202, and runs in a stack of composable, portable, and scalable containers (e.g. Kubernetes) on cloud, which can be public cloud hyperscalers. By utilizing the computing power of public cloud hyperscalers, the ML service 204, or components thereof (e.g., the ML services module 246) can be easily and quickly scaled up and scaled out to support the dynamic changes of ML model training demand.

In the train model phase, training occurs in the ML service 246 on cloud. In some examples, multiple stages of training are provided. A first stage of training includes static training (also referred to as offline training), in which the training dataset is relatively large. In static training, there are long lists of identified features, as described herein. As a result, the computing complexity and time of static training is significant. Static training only happens with the existing history dataset and only before deployment of the ML model. After static training, the ML model is saved in the ML model store 256 for later customization through dynamic training.

A second stage of training includes dynamic training (also referred to as online training), which occurs when the users interact with the multi-channel digital workplace system 202 (e.g., a user submits a request for engagement scores). In dynamic training, some features are defined, as described herein. The training dataset is also relatively small, only including relevant data. Accordingly, dynamic training is very efficient in terms of time and space complexity. The purpose of dynamic training is to customize the ML model to get a more accurate predication of engagement.

In further detail, the static ML model is retrieved from the ML model store 256 and is further trained with dynamic data. In this manner, the ML model is optimized for a specific period of time and a specific set of employees (e.g., customer care, R&D, sales). For example, the dynamic X-data that is generated from current content of a customer support team (e.g., text analytics of customer communications, speech recognition of customer conversation, interactions with a CRM application) is used in dynamic training. In some examples, recognized and extracted text is with a text analytics engine, which includes text mining and sentiment analysis functions, to generate quantitative values. The generated quantitative values together with other data from the operational current content are integrated into dynamic master data for the second stage of training on top of the static model fetched from ML model store 256. After dynamic training, the ML model is stored in active model cache 248 and is available for generating predictions.

During real-time prediction, the ML model is loaded by the inference engine 240 from the active model cache 248. The ML model is used to predict the most probable engagement scores in the future. In some examples, the prediction result is a time-series of engagement scores, which are saved in the prediction score store 230 in the multi-channel digital workplace 202. In some examples, the time-series of engagement scores includes historical engagement scores from analytics of historical data from EMD (e.g., historical engagement scores calculated from static X-Data), and current and future scores provided from the ML model. In some examples, an interactive chart is rendered and bound with engagement scores by a metadata-driven UI, which renders the interactive chart across multiple channels.

FIGS. 3A and 3B depict example UIs 300, 302, respectively, in accordance with implementations of the present disclosure. The example UI 300 includes a custom metrics UI that can be used to set values for respective metrics and respective groups of agents. In the depicted example, the metrics are set for a customer support team. The example UI 302 includes an interactive chart UI, which displays time-series data of engagement scores. In the depicted examples, the UI 302 includes time-series data of engagement scores for multiple groups including sales, customer support, and R&D. In accordance with implementations of the present disclosure, a first portion of each of the time-series data reflects historical engagement scores (e.g., calculated from X-Data) and a second portion of each of the time-series data reflects current and/or predicted engagement scores provided from the ML model. For example, the ML model can provide a current engagement score for a current date and provided future engagement scores for one or more future dates.

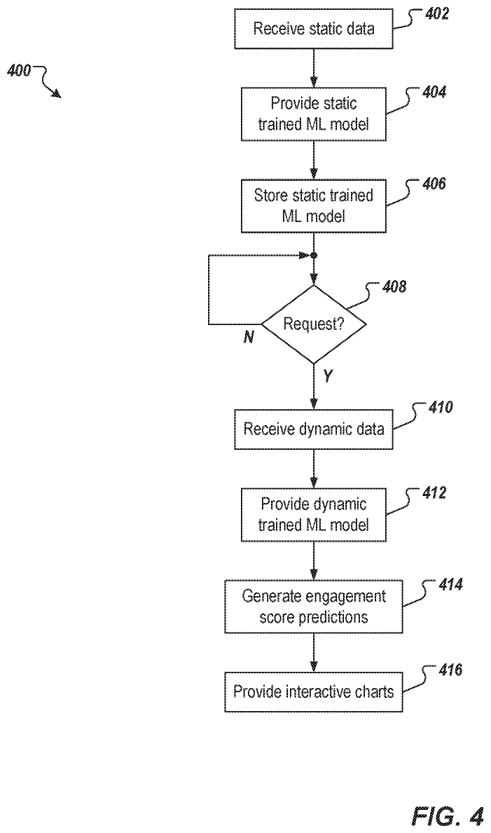

FIG. 4 depicts an example process 400 that can be executed in accordance with implementations of the present disclosure. In some examples, the example process 400 is provided using one or more computer-executable programs executed by one or more computing devices.

Static data is received (402). For example, the ML service 204 receives static data from the data system 206. In some examples, the static data includes static experience data including one or more historical engagement scores calculated based on at least a portion of the static experience data. A static trained ML model is provided (404). For example, the ML service 204 (e.g., the ML service module 246) trains an ML model using the static data to provide the static trained ML model, as described herein. The static trained ML model is stored (406). For example, the static trained ML model is stored in the model repository 242.

It is determined whether engagement scores are to be predicted (408). For example, the ML service 204 determines whether engagement scores are to be predicted. In some examples, an input can be provided from the multi-channel digital workplace, the input indicating a request to predict engagement scores. If engagement scores are not to be predicted, the example process 400 loops back. If engagement scores are to be predicted, dynamic data is received (410). For example, the ML service 204 receives dynamic data from the data system 206. A dynamic trained ML model is provided (412). For example, the ML service 204 (e.g., the ML service module 246) trains the static trained ML model using the dynamic data to provide the dynamic trained ML model, as described herein. In some examples, the dynamic data includes content data that is specific to a set of agents of multiple sets of agents within the enterprise to provide the dynamic trained ML model as specific to the set of agents.

One or more predicted engagement scores are generated (414). For example, the inference engine 240 processes input through the dynamic trained ML model to provide one or more predicted engagement scores. In some examples, one or more time-series data are provided, each time-series data including a first portion comprising one or more historical engagement scores and a second portion comprising at least one predicted engagement score of the one or more predicted engagement scores.

One or more interactive charts are provided (416). For example, the one or more predicted engagement scores are provided to the multi-channel digital workplace 202, which stores the one or more predicted engagement scores in the prediction score store 230, and the interactive charts module 222 generates the one or more interactive charts based on the one or more predicted engagement scores. In some examples, the one or more interactive charts are provided based on the one or more time-series data.

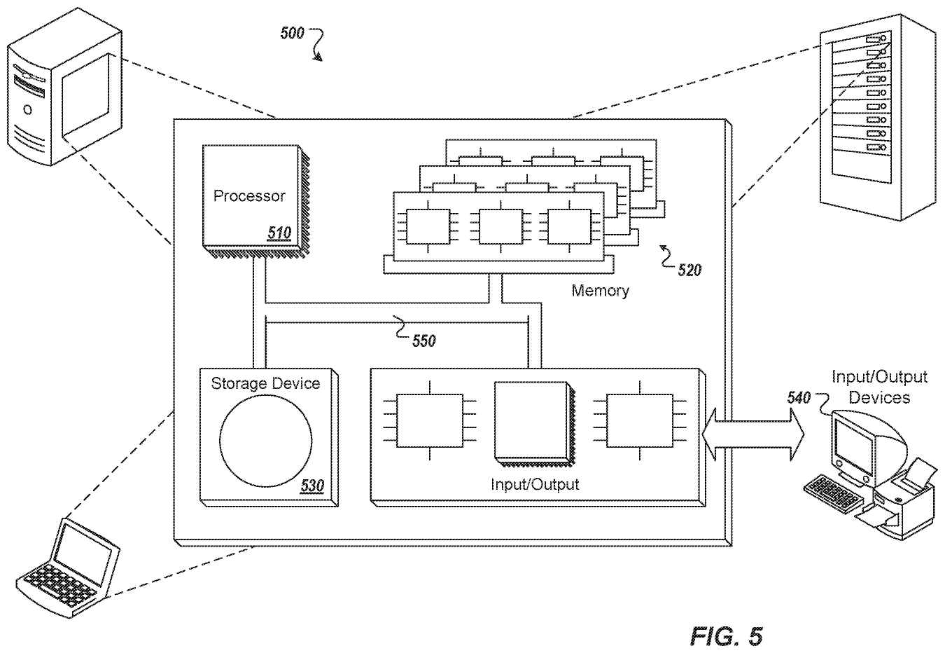

Referring now to FIG. 5, a schematic diagram of an example computing system 500 is provided. The system 500 can be used for the operations described in association with the implementations described herein. For example, the system 500 may be included in any or all of the server components discussed herein. The system 500 includes a processor 510, a memory 520, a storage device 530, and an input/output device 540. The components 510, 520, 530, 540 are interconnected using a system bus 550. The processor 510 is capable of processing instructions for execution within the system 500. In some implementations, the processor 510 is a single-threaded processor. In some implementations, the processor 510 is a multi-threaded processor. The processor 510 is capable of processing instructions stored in the memory 520 or on the storage device 530 to display graphical information for a user interface on the input/output device 540.

The memory 520 stores information within the system 500. In some implementations, the memory 520 is a computer-readable medium. In some implementations, the memory 520 is a volatile memory unit. In some implementations, the memory 520 is a non-volatile memory unit. The storage device 530 is capable of providing mass storage for the system 500. In some implementations, the storage device 530 is a computer-readable medium. In some implementations, the storage device 530 may be a floppy disk device, a hard disk device, an optical disk device, or a tape device. The input/output device 540 provides input/output operations for the system 500. In some implementations, the input/output device 540 includes a keyboard and/or pointing device. In some implementations, the input/output device 540 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier (e.g., in a machine-readable storage device, for execution by a programmable processor), and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. Elements of a computer can include a processor for executing instructions and one or more memories for storing instructions and data. Generally, a computer can also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, for example, a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

A number of implementations of the present disclosure have been described. Nevertheless, it will be understood that various modifications may be made without departing from the spirit and scope of the present disclosure. Accordingly, other implementations are within the scope of the following claims.

What is claimed is:

1. A computer-implemented method for predicting engagement in enterprises using a machine learning (ML)-based engagement prediction platform, the method being executed by one or more processors and comprising:
receiving, by a machine learning (ML) service of the ML-based engagement prediction platform, static data comprising static operational data and static experience data as enterprise master data (EMD) from an EMD database;
providing, by the ML service, a static trained ML model by training an ML model using the static data;
receiving, by the ML service, dynamic data comprising content data;
providing, by the ML service, a dynamic trained ML model by training the static trained ML model using the dynamic data;
generating, by the ML service, one or more predicted engagement scores using the dynamic trained ML model; and
providing, by a digital workplace of the ML-based engagement prediction platform, a user interface (UI) that includes an interactive chart that is rendered and bound with the one or more engagement scores using UI metadata that enables the interactive chart to be rendered across multiple channels.

2. The method of claim 1, wherein the static experience data comprises one or more historical engagement scores calculated based on at least a portion of the static experience data.

3. The method of claim 1, further comprising providing one or more time-series data, each time-series data comprising a first portion comprising one or more historical engagement scores and a second portion comprising at least one predicted engagement score of the one or more predicted engagement scores.

4. The method of claim 1, wherein the static operational data comprises operational data based on agent interactions with one or more software system executed within the enterprise, the one or more software systems comprising one or more of an enterprise resource planning (ERP) system, a customer relationship management (CRM) system, and a human capital management (HCM) system.

5. The method of claim 1, wherein the content data is specific to a set of agents of multiple sets of agents within the enterprise to provide the dynamic trained ML model as specific to the set of agents.

6. The method of claim 1, wherein the content data comprises data provided from one or more of verbal communications of agents and textual communications of agents.

7. The method of claim 1, wherein the ML model comprises a deep neural network (DNN).

8. A non-transitory computer-readable storage medium coupled to one or more processors and having instructions stored thereon which, when executed by the one or more processors, cause the one or more processors to perform operations for predicting engagement in enterprises, the operations comprising:
receiving, by a machine learning (ML) service of the ML-based engagement prediction platform, static data comprising static operational data and static experience data as enterprise master data (EMD) from an EMD database;
providing, by the ML service, a static trained ML model by training an ML model using the static data;
receiving, by the ML service, dynamic data comprising content data;
providing, by the ML service, a dynamic trained ML model by training the static trained ML model using the dynamic data;
generating, by the ML service, one or more predicted engagement scores using the dynamic trained ML model; and
providing, by a digital workplace of the ML-based engagement prediction platform, a user interface (UI) that includes an interactive chart that is rendered and bound with the one or more engagement scores using UI metadata that enables the interactive chart to be rendered across multiple channels.

9. The computer-readable storage medium of claim 8, wherein the static experience data comprises one or more historical engagement scores calculated based on at least a portion of the static experience data.

10. The computer-readable storage medium of claim 8, wherein operations further comprise providing one or more time-series data, each time-series data comprising a first portion comprising one or more historical engagement scores and a second portion comprising at least one predicted engagement score of the one or more predicted engagement scores.

11. The computer-readable storage medium of claim 8, wherein the static operational data comprises operational data based on agent interactions with one or more software system executed within the enterprise, the one or more software systems comprising one or more of an enterprise resource planning (ERP) system, a customer relationship management (CRM) system, and a human capital management (HCM) system.

12. The computer-readable storage medium of claim 8, wherein the content data is specific to a set of agents of multiple sets of agents within the enterprise to provide the dynamic trained ML model as specific to the set of agents.

13. The computer-readable storage medium of claim 8, wherein the content data comprises data provided from one or more of verbal communications of agents and textual communications of agents.

14. The computer-readable storage medium of claim 8, wherein the ML model comprises a deep neural network (DNN).

15. A system, comprising:
a computing device; and
a computer-readable storage device coupled to the computing device and having instructions stored thereon which, when executed by the computing device, cause the computing device to perform operations for predicting engagement in enterprises, the operations comprising:
receiving, by a machine learning (ML) service of the ML-based engagement prediction platform, static data comprising static operational data and static experience data as enterprise master data (EMD) from an EMD database;
providing, by the ML service, a static trained ML model by training an ML model using the static data;
receiving, by the ML service, dynamic data comprising content data;
providing, by the ML service, a dynamic trained ML model by training the static trained ML model using the dynamic data;
generating, by the ML service, one or more predicted engagement scores using the dynamic trained ML model; and
providing, by a digital workplace of the ML-based engagement prediction platform, a user interface (UI) that includes an interactive chart that is rendered and bound with the one or more engagement scores using UI metadata that enables the interactive chart to be rendered across multiple channels.

16. The system of claim 15, wherein the static experience data comprises one or more historical engagement scores calculated based on at least a portion of the static experience data.

17. The system of claim 15, wherein operations further comprise providing one or more time-series data, each time-series data comprising a first portion comprising one or more historical engagement scores and a second portion comprising at least one predicted engagement score of the one or more predicted engagement scores.

18. The system of claim 15, wherein the static operational data comprises operational data based on agent interactions with one or more software system executed within the enterprise, the one or more software systems comprising one or more of an enterprise resource planning (ERP) system, a customer relationship management (CRM) system, and a human capital management (HCM) system.

19. The system of claim 15, wherein the content data is specific to a set of agents of multiple sets of agents within the enterprise to provide the dynamic trained ML model as specific to the set of agents.

20. The system of claim 15, wherein the content data comprises data provided from one or more of verbal communications of agents and textual communications of agents.
